(19) United States
(12) Patent Application Publication
(10) Pub. No.: US 2023/0208858 A1
(43) Pub. Date: Jun. 29, 2023

(54) AUTOMATED CYBERATTACK DETECTION USING TIME-SEQUENTIAL DATA, EXPLAINABLE MACHINE LEARNING, AND/OR ENSEMBLE BOOSTING FRAMEWORKS

(71) Applicant: University of Florida Research Foundation, Incorporated, Gainesville, FL (US)

(72) Inventors: Prabhat Kumar Mishra, Gainesville, FL (US); Zhixin Pan, Gainesville, FL (US)

(21) Appl. No.: 18/045,563

(22) Filed: Oct. 11, 2022

Related U.S. Application Data
(60) Provisional application No. 63/271,893, filed on Oct. 26, 2021.

(51) Int. Cl. H04L 9/40

(52) U.S. Cl. CPC H04L 63/1416

(57) ABSTRACT

Various embodiments of the present disclosure provide systems, methods, and computer program products for detecting unauthorized memory access cyberattacks, such as Spectre and Meltdown, which are intended to maliciously reveal information stored in concealed or restricted memory of a targeted device.

### CROSS-REFERENCE TO A RELATED APPLICATION

This application claims the benefit of U.S. Provisional Application Ser. No. 63/271,893, filed Oct. 26, 2021, the disclosure of which is hereby incorporated by reference in its entirety, including all figures, tables and drawings.

### GOVERNMENT SUPPORT

This invention was made with government support under 1908131 awarded by the National Science Foundation. The government has certain rights in the invention.

### TECHNOLOGICAL FIELD

Embodiments of the present disclosure generally relate to systems and methods for detection of cyberattacks and cyber-threats, and in particular, cyberattacks oriented around unauthorized memory access such as the Spectre and the Meltdown attacks.

### BACKGROUND

Spectre and Meltdown are two example cyberattacks that are a serious threat to modern computer systems and have dramatically changed perception of hardware security vulnerabilities. Both Spectre and Meltdown enable malicious processes to access concealed memory locations without authorization with cache-based side channel attacks. Therefore, it is critical for trustworthy computing to detect Spectre attacks, Meltdown attacks, and other example cyberattacks oriented around unauthorized memory access. Various embodiments of the present disclosure address technical challenges relating to detection of such unauthorized memory access attacks including Spectre and Meltdown, and in particular, the explainability and efficiency of such detection objectives.

### BRIEF SUMMARY

Spectre and Meltdown are examples of cyberattacks that exploit security vulnerabilities of advanced architectural features to access inherently concealed memory data without authorization. Existing defense mechanisms have three major drawbacks: (i) they can be fooled by obfuscation techniques, (ii) their applicability is severely limited by a lack of transparency, and (iii) they can introduce unacceptable performance degradation. In various embodiments of the present disclosure, a detection scheme based at least in part on explainable machine learning that addresses these fundamental technical challenges is provided and described. Various embodiments described herein are shown to be effective in detecting exemplary Spectre and Meltdown attacks. In detection of these unauthorized memory access cyberattacks, various embodiments primarily utilize time-sequential, time-dependent, or temporal trends of hardware events through sequential timestamps as a supplement or as an alternative to overall statistical counts of hardware events. Various embodiments described herein have been demonstrated to significantly improve detection efficiency by about 38.4% on average in example studies.

### BRIEF DESCRIPTION OF THE DRAWINGS

Having thus described the present disclosure in general terms, reference will now be made to the accompanying drawings, which are not necessarily drawn to scale.

FIG. 1 provides a diagram describing advanced architectural features that are exploited by example unauthorized memory access cyberattacks, which are the detection objective of various embodiments of the present disclosure.

FIG. 2 illustrates example data describing vulnerability to cache-based side-channel attacks employed by unauthorized memory access cyberattacks, which are the detection objective of various embodiments of the present disclosure.

FIG. 3 provides a schematic diagram of a computing entity that may be used in accordance with various embodiments of the present disclosure.

FIG. 4 illustrates an example process for detecting unauthorized memory access cyberattacks based at least in part on configuration of a machine learning model to detect cyberattacks using time-sequential hardware event data, in accordance with various embodiments of the present disclosure.

FIGS. 5A-B illustrates classification of example sample data with respect to particular observed features of hardware event data, in accordance with various embodiments of the present disclosure.

FIG. 6 illustrates an example architecture of at least a portion of a machine learning model that is configured to interpret time-sequential hardware event data for the detection of unauthorized memory access cyberattacks, in accordance with various embodiments of the present disclosure.

FIG. 7 illustrates an example architecture of a machine learning model that is configured to interpret temporal hardware event data for the detection of unauthorized memory access cyberattacks, in accordance with various embodiments of the present disclosure.

FIG. 8 provides a diagram illustrating an example process for result interpretation through model distillation for configuration of a machine learning model to interpret temporal hardware event data for the detection of unauthorized memory access cyberattacks, in accordance with various embodiments of the present disclosure.

FIG. 9 provides a diagram illustrating an example process for data augmentation for configuration of a machine learning model to interpret temporal hardware event data for the detection of unauthorized memory access cyberattacks, in accordance with various embodiments of the present disclosure.

FIGS. 10A-B provides results from example studies demonstrating the improved detection efficiency provided by various embodiments of the present disclosure.

FIG. 11 provides a diagram illustrating an example ensemble boosting process for improving the accuracy and efficiency of machine learning models, in accordance with various embodiments of the present disclosure.

FIG. 12 provides a diagram illustrating an overview of a diffusion model-based data augmentation process, in accordance with various embodiments of the present disclosure.

FIG. 13 provides results from example studies demonstrating the improved detection efficiency provided by employing Shapley analysis in various embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### OVERVIEW

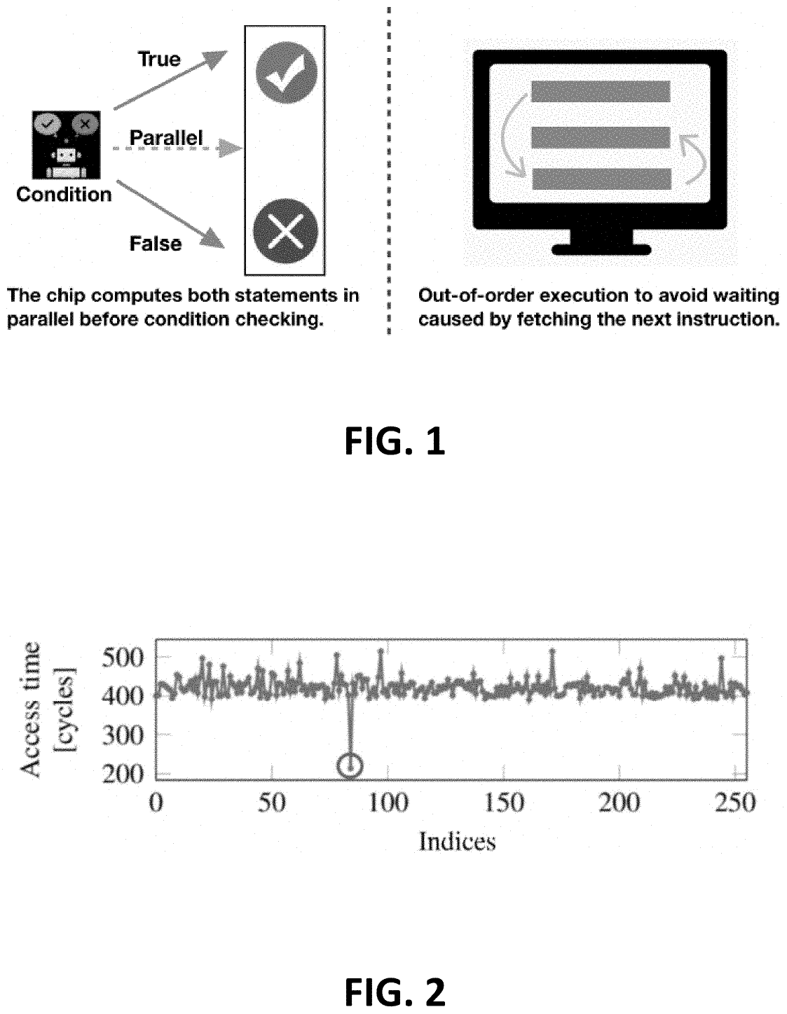

Processing speed of computing devices has been significantly boosted by speculative execution properties such as branch prediction and out-of-order execution. As depicted in FIG. 1, processors are able to perform parallel processing of predicted tasks with excess system resources by utilizing speculative execution. FIG. 1 illustrates, for example, that a processor may execute both program instructions that would result from a condition statement being evaluated as true and program instructions that would result from a condition statement being evaluated as false. This parallel processing of both branches of a condition statement, which may be referred to as branch prediction, is intended to improve processing speed of a program or process; however, this branch prediction capability is abused by some unauthorized memory access cyberattacks, such as Spectre, to successfully break memory isolation capabilities of a device. That is, example cyberattacks may exploit branch prediction to cause concealed or restricted memory locations to be accessed.

FIG. 1 further illustrates another speculative execution capability in out-of-order execution, in which program instructions may be executed in a non-specified non-sequential order to avoid waiting and delays caused by fetching program instructions (e.g., from memory) sequentially. Similarly, some example unauthorized memory access cyberattacks, such as Meltdown, exploit the out-of-order execution capability to access memory locations without authorization. In some example instances, Meltdown and other similar cyberattacks are capable of dumping kernel memory at a speed of 503 KB/s. Therefore, it is critical to detect unauthorized memory access cyberattacks, such as Spectre and Meltdown, that exploit these speculative execution capabilities in order to enable trustworthy computing.

Operating systems of example computing entities and devices have one of the most fundamental security requirements—to prevent user programs from accessing the memory locations of the kernel or any other programs. Once a user program tries to perform illegal access, the processor will detect the permission violation during the execution and throw an exception leading to the termination of current program. However, during this permission checking and scene clearing process, the information about accessing target is retained in the cache. These are inherent vulnerabilities in most of modern chips, which can be exploited by attackers to reveal kernel memory information specifically through exploitation of the aforementioned speculative execution capabilities of example computing entities and devices. Specifically, an example template of Meltdown attack code is shown in Listing 1.

Listing 1: Example Meltdown Attack

| | | | | |
|---|---|---|---|---|
| mov | rax | byte [x] | // | illegal access |
| shl | rax | OxC | // | page alignment |
| mov | rex | rbx [rax] | // | probe data |

In this example, byte[x] represents a private, concealed, restricted, and/or the like memory location, and illegal access to this location should raise exception during execution, and {rax, rbx, rcx} should be understood by those of skill in the field of the present disclosure as register names or identifiers for registers (these may alternatively be understood as {R1, R2, R3}, {$1, $2, $3}, {% r1, % r2, % r3} and/or the like). The left shift by 12 bits in the second instruction in this example enables multiplication of the load address in rax by the page size of the memory of the targeted device (e.g., 4096). Ideally, rax should be cleared before executing the subsequent instructions. However, due to the speculative execution property (specifically the out-of-order execution capability), the second and third example instructions will be partially executed before the exception handling takes effect. Also, according to the modern cache designs, if rax is not in the cache, the processor of the example computing entity or device execute a process having the Meltdown attack code will bring it into the cache to hide the latency of subsequent accesses. Although rax will be cleared by exception handling, the cache will not be flushed immediately. Therefore, the information of the latest illegal access is temporarily stored in the cache. An attacker can restore this private memory location through a cache-based side channel attack as shown in FIG. 2. Then, the entire array headed by rbx is traversed, and the access time of each index or page of the array is measured. The index with the shortest access time is the one addressed by rax due to rax being in the cache, and thereby this kernel value is obtained. As illustrated in FIG. 2, the page addressed by rax has a significantly lower access time compared to other pages of the entire array.

As previously discussed, the Spectre attack is another example unauthorized memory access cyberattack, and the Spectre attack specifically exploits branch prediction capabilities to access private, concealed, restricted, and/or the like memory locations. An example Spectre attack code is shown in Listing 2.

Listing 2: Example Spectre Attack

| | |
|---|---|
| if (x < arrl_size); | // boundary check |
| y = arrr2 [arrl [x] * 4096]; | // array access |

As understood by those of ordinary skill in the field to which the present disclosure pertains, the second line of program instruction should not be executed if the index variable “x” is out of range (e.g., greater than or equal to “arr1_size”, assuming zero-indexing of the array). However, due to branch prediction capability, the second line of program instruction is pre-executed before determination of whether the index variable “x” is indeed out of range. Once this pre-execution occurs, traces are left in the cache, where the same cache-based side-channel attack as demonstrated in FIG. 2 can be used. In some example instances, Spectre may be more dangerous compared to Meltdown due to a wider attack range.

Generally, it can be assumed that adversaries that design such unauthorized memory access cyberattacks such as Spectre and Meltdown have the goal of revealing values in concealed memory locations to cause information leakage. It can be further assumed that said adversaries possess information about the operating system of targeted computing entities and devices, as well as the hardware architecture of such targeted computing entities and devices. In various embodiments, it is assumed that adversaries are able to measure reaction time of targeted computing entities and devices towards memory fetching operations. With these assumptions, various embodiments are configured to provide reliable and efficient detection of unauthorized memory access cyberattacks that generally begin with raising exceptions during program execution, followed by cache-based side-channel attacks.

In particular, various embodiments of the present disclosure provide technical advantages in detection efficiency and accuracy compared to various existing detection systems and/or methods. Some existing detection approaches focus on mitigation techniques, such as enforcing processors of targeted computing entities or devices to empty branch target buffers during task switching or to occasionally shut down speculative execution capabilities. However, such existing detection approaches can lead to unacceptable performance degradation. Some other existing detection approaches have inherent weaknesses in detecting unauthorized memory access cyberattacks in the presence of obfuscation techniques or other deviation capabilities and in providing detection results that cannot be interpreted in a meaningful way.

Therefore, there are two overall and major technical problems affecting the performance of existing detection efforts: high overhead and poor robustness. First, passive prevention through shutting down of speculative execution capabilities to prevent possible attacks inevitably leads to significant reduction in performance and unacceptable overhead. Similarly, architectural alternation increases the burden of the detection pipeline. Moreover, considerable time for detection is required before normal execution of a program can proceed.

With regard to poor robustness, some existing approaches are easily fooled and vulnerable towards obfuscation techniques. These existing approaches rely upon hardware performance counter (HPC) values obtained from HPCs, which are components in microprocessors that monitor hardware events, such as cache misses and branch misprediction. While unauthorized memory access cyberattacks leave evidence in HPCs because such cyberattacks are based on triggering exceptions and cache access measurements, the HPC values can be manipulated by adversaries using obfuscation techniques. Essentially, benign functions between malignant payloads can be invoked, and instructions that increase specific HPC values (e.g., number of branch mispredictions) can be inserted in order to fool such existing detection approaches. In some example instances, obfuscation techniques can cause an existing detector to have a less than 60% detection rate, almost comparable to a random guess.

Various embodiments improve upon the high overhead and the poor robustness of these existing detection approaches. In particular, various embodiments of the present disclosure are rooted in hardware-based detection, which provides lower latency compared to software-based solutions. Specifically, various embodiments include a hardware-assisted detection framework that incorporates explainable machine learning models to analyze close relationships between hardware events and inherent features of unauthorized memory access cyberattacks.

In various embodiments, explainable machine learning models provide advantages over normal machine learning models, which have a black-box nature and provide no additional information apart from a detection result. As a result, users gain no clues from incorrect predictions made from normal machine learning models, and this lack of transparency hinders the objective of detecting unauthorized memory access attacks. In particular, an understanding of why a detection result is incorrect is vital in detecting cyberattacks through obfuscation techniques and in providing improved robustness. As such, various embodiments described herein implement explainable machine learning concepts, as well as data augmentation processes in order to provide improved robustness.

Therefore, various embodiments provide cyberattack detection with higher credibility and particularly, robustness against obfuscation techniques. In various embodiments, hardware events are utilized as time-sequential inputs to mitigate misprediction induced by obfuscation techniques, enabling an incorporated machine learning model to be resistant against evasive attacks. Example studies have been completed to demonstrate that various embodiments described herein can provide significant improvement in detection accuracy and robustness compared to existing detection approaches.

### Computer Program Products, Systems, Methods, and Computing Entities

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Exemplary Computing Entity

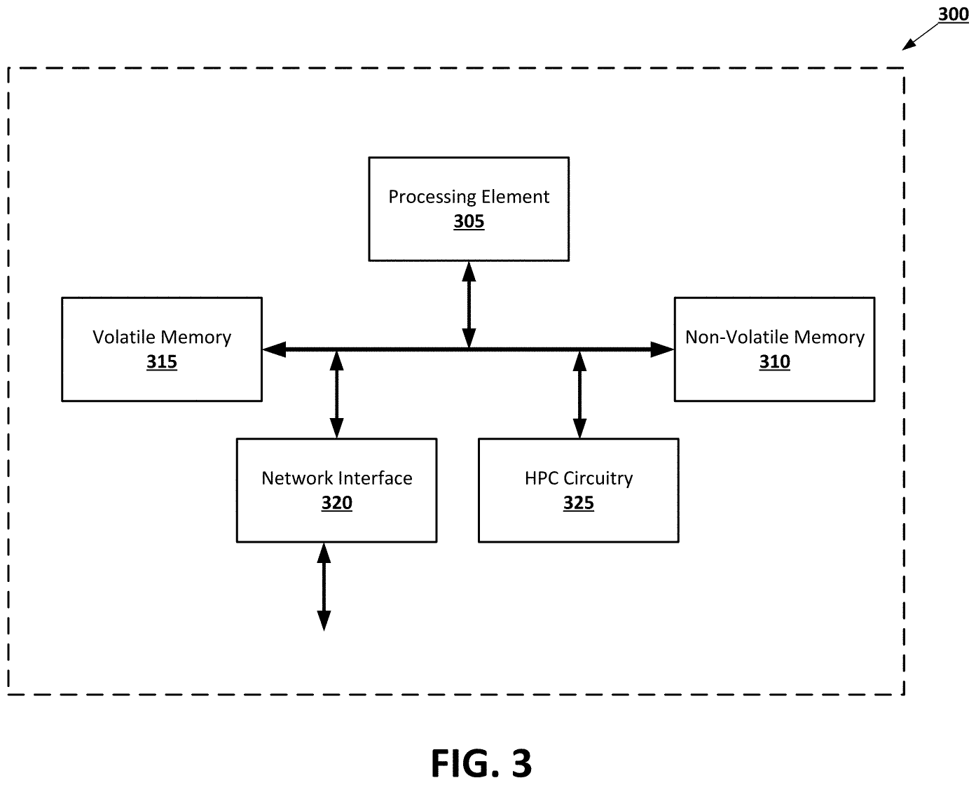

FIG. 3 provides a schematic of an exemplary computing entity 300 that may be used in accordance with various embodiments of the present disclosure. For instance, the computing entity 300 may be a device targeted by unauthorized memory access cyberattacks via Spectre-based and/or Meltdown-based malicious programs, and the computing entity 300 may be configured to detect such unauthorized memory access cyberattacks in accordance with various embodiments of the present disclosure, in some example embodiments. In various other example embodiments, the computing entity 300 is configured to monitor a second device that may be targeted by unauthorized memory access cyberattacks and is configured to detect such unauthorized memory access cyberattacks in real-time during execution of programs on the second device. In either regard, the computing entity 300 may be generally configured to detect unauthorized memory access cyberattacks using one or more machine learning models configured using explainable machine learning concepts and through interpretation of certain hardware events in a time-sequential and/or time-dependent fashion.

In general, the terms computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

Although illustrated as a single computing entity, those of ordinary skill in the field should appreciate that the computing entity 300 shown in FIG. 3 may be embodied as a plurality of computing entities, tools, and/or the like operating collectively to perform one or more processes, methods, and/or steps. As just one non-limiting example, the computing entity 300 may comprise a plurality of individual data tools, each of which may perform specified tasks and/or processes.

Depending on the embodiment, the computing entity 300 may include one or more network and/or communications interfaces 320 for communicating with various computing entities, such as by communicating data, content, information, and/or similar terms used herein interchangeably that can be transmitted, received, operated on, processed, displayed, stored, and/or the like. Thus, in certain embodiments, the computing entity 300 may be configured to receive data from one or more data sources and/or devices, as well as receive data indicative of input, for example, from a device. For example, the computing entity 300 receives time-sequential hardware event data collected at and/or describing hardware events at a different computing entity (e.g., a device being monitored by the computing entity 300).

The networks used for communicating may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks may have any suitable communication range associated therewith and may include, for example, global networks (e.g., the Internet), MANs, WANs, LANs, or PANs. In addition, the networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Accordingly, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 300 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 300 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

In addition, in various embodiments, the computing entity 300 includes or is in communication with one or more processing elements 305 (also referred to as processors, processing circuitry, and/or similar terms used herein interchangeably) that communicate with other elements within the computing entity 300 via a bus, for example, or network connection. As will be understood, the processing element 305 may be embodied in several different ways. For example, the processing element 305 may be embodied as one or more complex programmable logic devices (CPLDs), microprocessors, multi-core processors, coprocessing entities, application-specific instruction-set processors (ASIPs), and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 305 may be configured for a particular use or configured to execute instructions stored in volatile or non-volatile media or otherwise accessible to the processing element 305. In various embodiments, the processing element 305 is configured to execute instructions (e.g., of a program, of a process) with speculative execution capabilities, such as branch prediction and/or out-of-order execution as described in FIG. 1. In various embodiments, the processing element 305 is configured to execute instructions of a potentially harmful or malicious program that may or may not include instructions for an unauthorized memory access cyberattack, while also executing instructions for detection of unauthorized memory access cyberattacks in accordance with various embodiments of the present disclosure. That is, the processing element 305 may be configured to perform steps or operations for real-time detection of unauthorized memory access cyberattacks during real-time execution of potentially harmful or malicious programs. As such, whether configured by hardware, computer program products, or a combination thereof, the processing element 305 may be capable of performing steps or operations according to embodiments of the present disclosure when configured accordingly.

In various embodiments, the computing entity 300 may include or be in communication with non-volatile media (also referred to as non-volatile storage, memory, memory storage, memory circuitry and/or similar terms used herein interchangeably). For instance, the non-volatile storage or memory may include one or more non-volatile storage or non-volatile memory media 310 such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or non-volatile memory media 310 may store files, databases, database instances, database management system entities, images, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium. In particular, the non-volatile memory media 310 stores at least a portion of the operating system (OS) or kernel for the computing entity 300, and may store said portions of the OS or kernel in a secure, private, concealed, restricted, and/or the like manner. For example, in some instances, the processing element 305 may be configured to cause an exception when a program with inadequate permissions (e.g., a user program) attempts to access portions of the non-volatile memory media 310 storing the OS or kernel.

In particular embodiments, the non-volatile memory media 310 may also be embodied as a data storage device or devices, as a separate database server or servers, or as a combination of data storage devices and separate database servers. Further, in some embodiments, the non-volatile memory media 310 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. As already discussed, various embodiments contemplated herein use data storage in which some or all the information/data required for various embodiments of the disclosure may be stored.

In various embodiments, the computing entity 300 may further include or be in communication with volatile media (also referred to as volatile storage, memory, memory storage, memory circuitry and/or similar terms used herein interchangeably). For instance, the volatile storage or memory may also include one or more volatile storage or volatile memory media 315 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In particular, volatile storage or volatile memory media 315 of the computing entity 300 includes the cache or cache memory, which may be exploited in unauthorized memory access cyberattacks to reveal information stored in private, concealed, restricted, and/or the like portions of the non-volatile storage or non-volatile memory media 310.

As will be recognized, the volatile storage or volatile memory media 315 may be used to store at least portions of the databases, database instances, database management system entities, data, images, applications, programs, program modules, scripts, source code, object code, byte code, compiled code, interpreted code, machine code, executable instructions, and/or the like being executed by, for example, the processing element 305. Thus, the databases, database instances, database management system entities, data, images, applications, programs, program modules, scripts, source code, object code, byte code, compiled code, interpreted code, machine code, executable instructions, and/or the like may be used to control certain aspects of the operation of the computing entity 300 with the assistance of the processing element 305 and operating system.

In various embodiments, the computing entity 300 includes HPC circuitry 325 comprising one or more hardware performance counters. As previously discussed, a hardware performance counter is a component that may communicate with, be integrated within, and/or the like the processing element 305 and is configured to monitor hardware events in relation to non-volatile memory media 310 and volatile memory media 315. In particular, HPC circuitry 325 is configured to monitor and record data describing cache misses by the processing element 305 in volatile memory media 315, branch mis-prediction by the processing element 305 when retrieving and pre-executing instructions stored in non-volatile memory media 310 and/or volatile memory media 315, and/or the like. Thus, HPC circuitry 325 is configured to generate hardware event data in real-time during execution of programs and instructions by processing element 305. In various embodiments, HPC circuitry 325 is configured to provide such hardware event data to the processing element 305, upon which, the processing element 305 is configured to interpret the hardware event data in a time-sequential manner for the detection of unauthorized memory access cyberattacks. Additionally or alternatively, the computing entity 300 is configured to receive hardware event data collected by HPC circuitry of a different device and is configured to interpret the hardware event data for the different device for the detection of unauthorized memory access cyberattacks that may be running on the different device.

As will be appreciated, one or more of the computing entity's components may be located remotely from other computing entity components, such as in a distributed system. Furthermore, one or more of the components may be aggregated and additional components performing functions described herein may be included in the computing entity 300. Thus, the computing entity 300 can be adapted to accommodate a variety of needs and circumstances.

### EXEMPLARY OPERATIONS

Various embodiments of the present disclosure address technical challenges related to detection of unauthorized memory access cyberattacks, namely performance overhead and robustness in view of obfuscation techniques. In various embodiments, overhead and robustness of cyberattack detection is improved, and detection accuracy of unauthorized memory access cyberattacks is similarly improved. Various embodiments involve interpretation of time-sequential hardware event data. In various embodiments, a machine learning model is configured using explainability such that key features of time-sequential hardware event data that are indicative of a cyberattack are uncovered and identified. Machine learning models implemented in various embodiments of the present disclosure include distilled machine learning models that are generated using the key features of time-sequential hardware event data uncovered through explainability of an initial machine learning model. Additionally, Shapley Analysis can be applied to the machine learning models implemented in various embodiments in order to aid in explaining which specific hardware events lead to the respective outputs of the machine learning models. While various embodiments of the present disclosure are described with respect to detection of Spectre and Meltdown attacks, it will be understood that Spectre and Meltdown attacks are used as illustrative examples to describe and demonstrate accuracy of various embodiments of the present disclosure directed to the detection of unauthorized memory access cyberattacks.

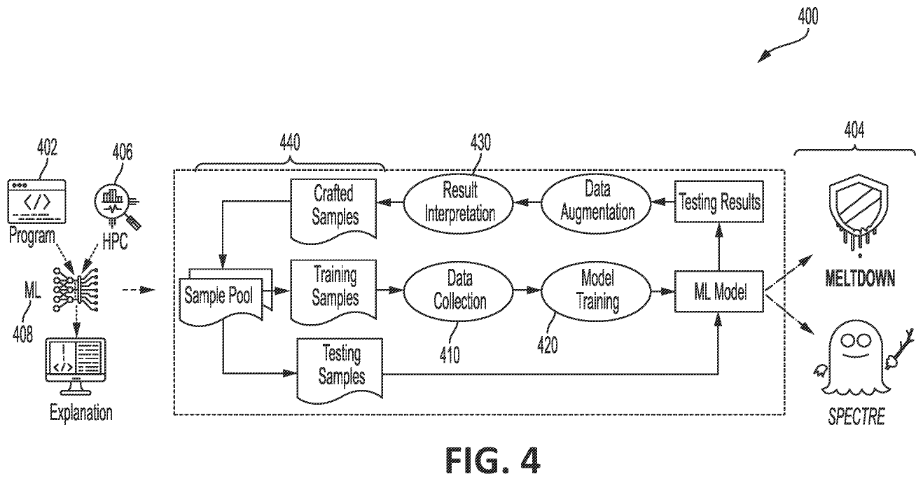

FIG. 4 illustrates an overview of a detection process 400, mechanism, framework, and/or the like that implements explainable machine learning. In various embodiments, steps, operations, tasks, and/or the like of the detection process 400 may be performed in order to classify a program 402 as a malicious program (e.g., a program including an unauthorized memory access cyberattack 404 such as Spectre or Meltdown). This classification is obtained via interpretation of time-sequential hardware event data 406 using a machine learning model 408 configured for detection of unauthorized memory access cyberattacks. In various embodiments, the machine learning model 408 is configured to provide explanation of relationships between features in the time-sequential hardware event data 406 and characteristics of unauthorized memory access cyberattacks such that the machine learning model 408 can be configured (e.g., distilled) to efficiently classify a program 402.

Using the detection process 400 provided in the illustrated embodiment, at least two technical advantages are provided. Hardware features such as HPC circuitry 325 (e.g., of the computing entity 300, of a device being monitored and potentially targeted by an adversary) are efficiently utilized with minimal impact on overhead. Example processes in accordance with the illustrated embodiment further include effective countermeasures to protect against obfuscation techniques. In various embodiments, the computing entity 300 comprises means, such as processing element 305, non-volatile memory media 310, volatile memory media 315, HPC circuitry 325, and/or the like, for performing various steps/operations of detection process 400.

In one example embodiment, the computing entity 300 may be executing a potentially harmful or malicious program that includes an unauthorized memory access cyberattack, and the computing entity 300 comprises means for real-time detection of the unauthorized memory access cyberattack through performing at least some of the steps/operations of the detection process 400. In another example embodiment, the computing entity 300 may be monitoring execution of a potentially harmful or malicious program executing on a different and separate computing entity or device, and the computing entity 300 comprises means for real-time detection of unauthorized memory access cyberattacks executing on the different and separate computing entity or device. In some example embodiments, the different and separate computing entity or device is a quarantined, virtual, and/or the like computing entity.

As illustrated in FIG. 4, the detection process 400 comprises at least four major tasks. These four tasks include (i) data collection 410, (ii) model training 420, (iii) result interpretation 430, and (iv) adversarial training 440. In various embodiments, the detection process 400 is performed iteratively, with each task being repeated sequentially. These four tasks 410-440 may be performed to configure, train, and distill the machine learning model 408 to efficiently and accurately classify a program 402. As an initial high-level description, data collection 410 involves execution and running of both benign/normal and malicious programs to collect hardware event data using HPC circuitry 325. This data may be considered as the initial sample pool. Next, several important hardware events (e.g., LLCR, LLCM) are selected as critical features to be fed into a machine learning training process. At model training 420, a machine learning model having a structure based at least in part on a recurrent neural network is trained with stochastic gradient descent.

Then, at result interpretation 430, the trained model is tested through sufficient number of test samples to produce classification results. These results are utilized at result interpretation 430 to provide crucial information regarding the input features that are most relevant (or misleading) for classification. At adversarial training 440, adversarial samples are crafted based at least in part on the analysis obtained from result interpretation 430, and these adversarial samples (e.g., synthesized samples) are mixed into the original sample pool to retrain the machine learning model 408. Thus, in various embodiments, the machine learning model 408 continuously improves itself until the convergence of the testing accuracy, upon which the machine learning model 408 can be utilized for automatic, efficient, accurate, and robust cyberattack detection.

In various embodiments, the first step for training of the machine learning model 408 is to collect and determine the format of model inputs. As previously discussed, hardware events can be utilized to have lower latency than software detection approaches. Considering that there are a wide variety of hardware events monitored by HPC circuitry 325, various embodiments involve the selection of a small set of hardware event data that is beneficial for ML-based attack detection. Generally, hardware event data can include the total number of instructions, which can provide system-wide information of the current process. The out-of-order memory lookup, for example in the Meltdown attack, generates significantly high number of page faults, which can be used as an effective indicator. For unauthorized memory access cyberattacks whose attack vector may be similar to the Spectre attack with abuse of branch prediction capabilities, branch miss rate may be effective hardware event data. Branch miss rate may be calculated based at least in part on the total number of branch instructions and mispredictions. Moreover, since example unauthorized memory access cyberattacks rely on a cache-based side channel attack, the total number of low-level cache (LLC) references and misses to detect suspicious cache events may be collected in the hardware event data. This selection of six critical features in hardware event data are shown in Table I.

TABLE 1

| Hardware events | Event ID | Spectre | Meltdown |
|---|---|---|---|
| Total number of instructions | INS | ✓ | ✓ |
| Total page faults | PGF | X | ✓ |
| Total branch instruction | BRC | ✓ | X |
| Branch Miss-Predictions | BMP | ✓ | X |
| Low-Level cache reference | LLCR | ✓ | ✓ |
| Low-Level cache misses | LLCM | ✓ | ✓ |

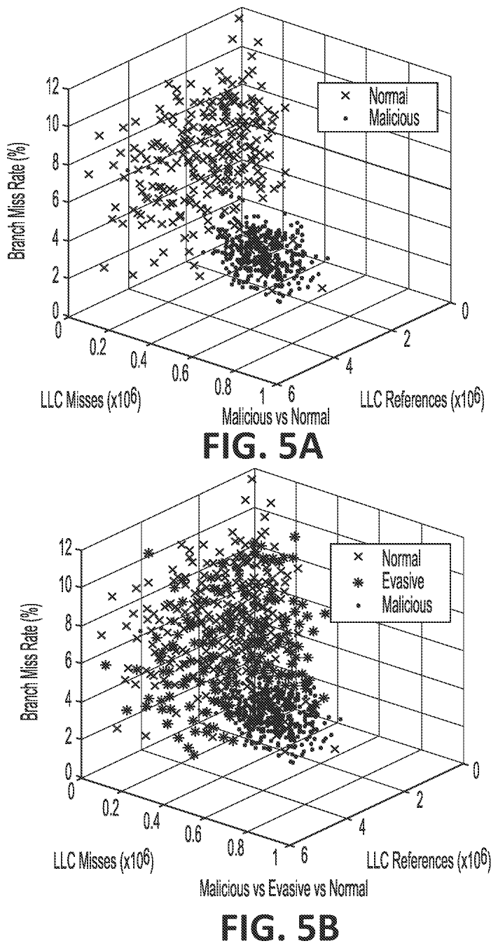

A straightforward way of formatting these events would be crafting vectors composed of the above selected features. Interestingly, this naive strategy may have efficacy in some example instances, as shown in FIG. 5A. FIG. 5A plots the distribution of normal and malicious Spectre attack samples with the three features of hardware event data that are low-level cache references (LLCR), low-level cache misses (LLCM), and branch miss rate. As shown, the cluster of malicious samples are clearly distinguishable from that of normal ones, and both the regions and boundary between two classes are obvious. This observation validates that these three features may be helpful in detecting attacks.

However, this naive approach of total counts of each event fails against evasive attacks. In evasive attacks, the adversary can simply add redundant non-profitable loops or cache-access statements, which enables the malicious program to mimic the pattern collected from benign programs, making the overall statistics indistinguishable from normal programs. This is depicted in FIG. 5B, in which the distribution of evasive Spectre program samples are also plotted. Evasive Spectre programs include these obfuscation techniques with redundant or decoy statements to cause artificial inflation of counts of certain hardware events. As shown, the cluster of evasive samples is mingled with normal ones, and there is no clear boundary to distinguish them. As demonstrated, evasive attacks drastically reduces the performance of detection when such naive features are used.

To address this, time-sequential hardware event data 406 may additionally or alternatively be selected as distinguishing features between normal, malicious, and evasive programs. Table 2 provides an event tracing table including example time-sequential hardware event data 406.

TABLE 2

Time

| Events | x₀ | x₁ | x₂ | x₃ |
|---|---|---|---|---|
| Δ BMR | 0.5 | 1.1 | −0.1 | . . . |
| Δ LLCR | 59 | 83 | 46 | . . . |
| Δ LLCM | 11 | 26 | 16 | . . . |
| . . . | | | | |

In various embodiments, HPC circuitry 325 is used to sample hardware events in multiple timestamps, and the differences in the amount of hardware events across the multiple timestamps are recorded (e.g., in an event tracing table such as Table 2). This approach of time-sequential or time-dependent hardware event data can be used in conjunction with and/or instead of the naive approach previously described involving features of hardware event counts.

Each row of the event tracing table of Table 2 represents a specific selected hardware events. For example, Table 2 includes rows for branch miss rate (BMR), low-level cache references (LLCR), and low-level cache misses (LLCM), and the A symbol indicates that each entry of the event tracing table represents the increase or decrease of the corresponding event compared to the previous timestamp (e.g., xᵢ₋₁). For instance, at timestamp x₁, the number of LLCRs has increased by 83 since the previous timestamp x₀. As another example, at timestamp x₂, the branch miss rate decreases by 0.1% since the previous timestamp x₁. Since the hardware events are considered in sequential timestamps instead of overall statistics, a natural advantage of this strategy is that it grants the machine learning model 408 with potential information concealed in consecutive adjacent inputs.

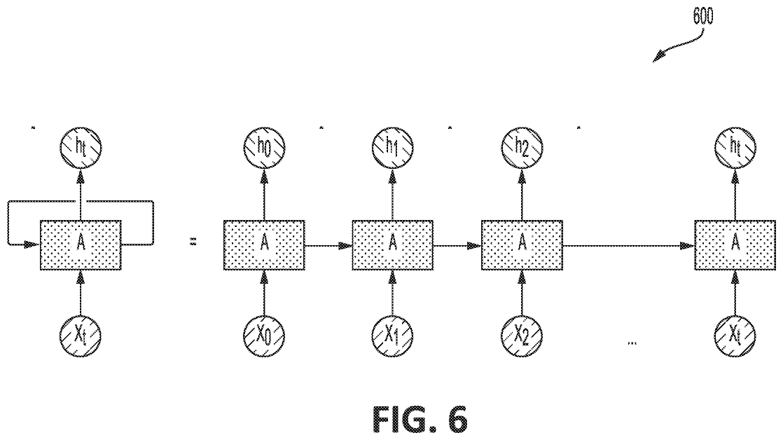

Using time-sequential hardware event data 406, the machine learning model 408 can be trained at model training 420. Because time-dependency and temporal aspects of the time-sequential hardware event data 406 are of interest, a major structure included in the machine learning model 408 may be configured as a recurrent neural network (RNN) model. FIG. 6 illustrates an example architecture of an RNN model 600 represented by A, where x₀, x₁, . . . , xₜ represent time series inputs (e.g., time-sequential hardware event data 406, columns of the event tracing table in Table 2). In the illustrated embodiment, h₀, h₁, . . . , hₜ represent hidden layer outputs, or representations of the time-sequential hardware event data 406 at each timestamp as generated by the RNN model 600.

As illustrated in FIG. 6, for each single input xᵢ, the RNN model 600 not only provides an immediate response hᵢ, but also feeds information corresponding to the previous step (e.g., i−1) to supply extra information. This mapping can be understood by unrolling the RNN structure as shown in FIG. 6. To avoid vanishing gradient and exploding gradient problems associated with RNN models generally, various embodiments implement the RNN model 600 as a long-short term memory (LSTM)-based model. An LSTM is a special type of RNN that utilizes special units in addition to basic configuration. LSTM adopts a memory cell that can maintain information in memory for long periods of time. At the same time, a set of gates is used to control the information flow inside LSTM's structure. This LSTM-based architecture enables longer-term dependencies over time to be learned.

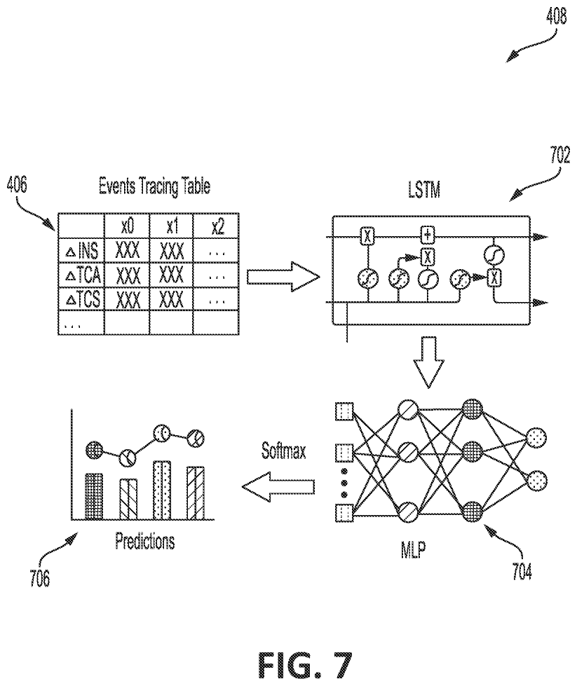

The LSTM of the machine learning model 408 works as an auto-encoder to map the original time-sequential hardware event data 406 to the hidden feature outputs; however, another structure is still needed to map the learned distributed feature representation to a more sophisticated feature space. Therefore, in various embodiments, the output of the last layer of the LSTM passes through a multilayer perceptron (MLP) neural network. Finally, the output of the MLP is normalized by a softmax layer to generate binary prediction labels, where a cross-entropy function is applied to produce the training loss. The gradient of loss is fed into a stochastic gradient descent (SGD) method to update model parameters (e.g., at the LSTM, at the MLP). The overall structure of the machine learning model 408 is outlined in FIG. 7. FIG. 7 illustrates the structure of the machine learning model 408 including two major components, the LSTM 702 and the MLP 704. As illustrated, the time-sequential hardware event data 406 is first provided to the LSTM 702, and the hidden layer outputs of the LSTM 702 are then fed to the MLP 704. The output of the last hidden layer of the MLP 704 passes through the softmax function to produce prediction outputs 706 for a program sample described by the time-sequential hardware event data 406.

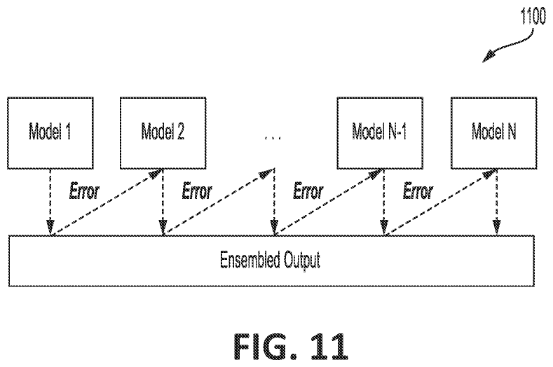

Additionally, in various embodiments, an ensemble boosting framework can be used to refine the machine learning model 408 and to improve training efficiency and training speed of the machine learning model 408. Ensemble boosting is a machine learning technique to improve the accuracy of predictive models, which creates stronger machine learning models by combining multiple weaker machine learning models, such as decision trees. The individual machine learning models are trained sequentially, with each machine learning model compensating for the errors of the previous machine learning model. A final prediction is made by combining the predictions of all the individual machine learning models. Ensemble boosting can be used for regression and classification tasks and is a powerful tool for dealing with complicated tasks. Ensemble boosting is also relatively resistant towards overfitting problems and achieves high levels of accuracy without sacrificing generalization. This can also lead to faster prediction since multiple machine learning models can work in parallel at run-time. FIG. 11 shows an overview of an ensemble boosting framework 1100. The ensemble boosting framework 1100 illustrated in FIG. 11 includes of a set of weak machine learning models where subsequent machine learning models focus on addressing the weaknesses of previous machine learning models. The final classifications, decisions, and/or predictions are based on an overall result generated based on each machine learning model's output.

In various embodiments, such as where the machine learning model 408 is configured as a recurrent neural network (RNN) model (e.g., RNN model 600), ensemble boosting can be used to refine and improve the accuracy and efficiency of the machine learning model 408. For instance, previous iterations of the machine learning model 408 can be ensembled together to refine a current iteration of the machine learning model 408. Additionally, in various embodiments, previous iterations of the machine learning model 408 can be run in parallel to increase the speed in which a classification, decision, and/or prediction can be generated.

Algorithm 1 describes using a cross-entropy function to determine loss between the prediction outputs 706 and labels (e.g., malicious, normal) of the input program sample, and the cross-entropy loss is used to update model parameters using stochastic gradient descent (sgd) until the machine learning model 408 reaches a configurable convergence threshold. Thus, Algorithm provides an example process for configuring and training the machine learning model 408, which may have the example architecture illustrated in FIG. 7.

Algorithm 1: Model Training

| | Input : Model Inputs {xᵢ} |
|---|---|
| | Output: Trained Model A |
| 1 | initialize(A) |
| 2 | h₀ = A(x₀) |
| 3 | repeat |
| 4 | for i = 1...t do |
| 5 | \| [symbol] hᵢ = A(xᵢ, hᵢ₋₁) |
| 6 | \| res = softmax(hₜ) |
| 7 | \| loss = cross_entropy(res,label) |
| 8 | \| A = sgd(A, ∇loss) |
| 9 | until converge; |
| 10 | Return A |

Returning to FIG. 4, the detection process 400 includes result interpretation 430, which involves applying explainable machine learning concepts to interpret detection outcome, or the prediction outputs 706 of the machine learning model 408. Training of the machine learning model 408 as described by example in Algorithm 1 may enable the machine learning model 408 to be applied in some example detection applications; however, the machine learning model 408 may remain vulnerable towards obfuscation techniques. Thus, various embodiments involve result interpretation 430 using explainability.

In general, explainability in machine learning seeks to provide interpretable explanation for the results (e.g., the prediction outputs 706, classification of a malicious program or a normal program) of a machine learning model. Given an input instance x and a traditional machine learning model, the classifier of the machine learning model will generate a corresponding output y for x during the testing time. Explanation techniques then aim to illustrate why instance x is classified into y. In various embodiments, explainability can be provided by identifying a set of important features inside x (e.g., specific portions of the time-sequential hardware event data 406) that make key contributions to the classification result. If the selected features are interpretable by human analysts, these features can offer an explanation.

In some examples, gradient-based methods successfully provide explainable and interpretable machine learning by computing an image-specific class saliency map corresponding to the gradient of output neurons. As another example, integrated gradients is a variation of a saliency map where integral methods are adopted to improve the information acquisition. In some further examples, various explainable machine learning techniques utilize deconvolution concepts to inverse and visualize the feature learning in convolution neural networks (CNNs). As a further yet example, DeepLIFT is another popular algorithm that was designed to observe the activation effects of each neuron of a machine learning model, and to assign contribution scores to each neuron.

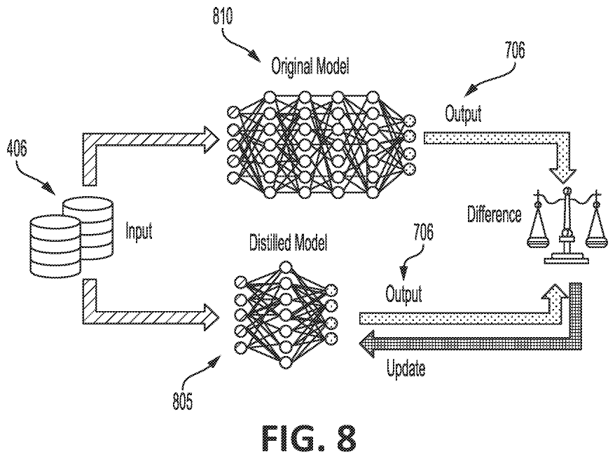

In various embodiments, explainability can be provided through model distillation and Shapley analysis. The basic idea of model distillation is that a separate machine learning model, referred to as a distilled machine learning model is developed to be an approximation of the input-output behavior of the target machine learning model (e.g., the original machine learning model). This distilled machine learning model is inherently explainable, which helps a user to identify the decision rules or input features influencing the final decision. FIG. 8 illustrates a diagram illustrating model distillation, or specifically the generation and configuration of a separate distilled machine learning model 805 from an original machine learning model 810. In some example embodiments, the original machine learning model 810 may be the machine learning model 408 configured for detection of unauthorized memory access cyberattacks, for example. In various embodiments, the goal of model distillation is to minimize the differences of input-output mapping behaviors between the original machine learning model 810 (e.g., the machine learning model 408) and the distilled machine learning model 805. Interpretation and analysis of the distilled machine learning model 805 after such minimization can provide insights into the internal representation of input data (e.g., time-sequential hardware event data 406) used to generate the prediction outputs 706. In various embodiments, lightweight structures and architecture are preferred for the distilled machine learning model 805. For example, the distilled machine learning model 805 may include linear regression mechanisms, a decision tree, an object graph, and/or the like, in various embodiments.

Generally, explainability, as provided via a distilled machine learning model 805 for example, provides major technical advantages in detection of unauthorized memory access cyberattacks. First, explainability may be used to help identify critical features in time-sequential hardware event data 406, such that only a small set of crafted samples are needed to satisfy adversarial training. In the absence of explainability, one would need extensive training with a large number of samples to fully configure and train a machine learning model 408 to accurately detect unauthorized memory access cyberattacks, which can be expensive in terms of both space and time. In various embodiments, explainability also helps in interpreting the prediction in a human understandable way that can be used to handle incorrect classification results.

Thus, in various embodiments, application of explainable machine learning concepts to interpret detection outcomes can be further utilized to synthesize evasive data samples. These synthesized samples are merged into the pool of training set to retrain the machine learning model 408, thereby enhancing the robustness of model against known attacks. Intuitively, this process is similar to vaccine treatment which involves diagnosing the patient to detect a pathogen and enhancing immunity towards a particular disease by preventive vaccination.

As discussed, various embodiments utilize model distillation to achieve result interpretation 430, and model distillation may specifically include three major steps: (i) model specification, (ii) model computation, and (iii) outcome explanation.

First, model specification involves specifying the type of distilled machine learning model 805. This often involves a trade-off between transparency and expression ability. A complex model can offer better performance in mimicking the behavior of the original model. However, increasing complexity also leads to the drop of model transparency, where the distilled model itself becomes hard to explain, and vice versa. Thus, various embodiments use a linear regression model as a distilled machine learning model 805 for its simplicity and interpretability

At model computation, once the type of distilled machine learning model 805 (denoted by A*) is determined, test samples are passed through the original model A to produce sufficient number of input-output pairs, in various embodiments. The model computation task aims at searching for optimal parameters θ to minimize the difference between A and A*, or specifically the difference between the outputs of A and A* when given the same input. In various embodiments in which linear regression models are selected for the distilled machine learning model 805, model computation can be represented as a least-squares problem, which can be solved efficiently. Equation 1 below provides an example least-squares problem for model computation. In Equation 1, the vector xᵢ=[xᵢ₁, xᵢ₂, . . . ] represents the i-th input.

$$θ = arg {min}_{θ} {\sum }_{i = 1}^{n} {‖ {A}_{θ}^{*} ( {x}_{i} ) - A ( {x}_{i} ) ‖}_{2} \qquad Equation 1$$

In various embodiments, outcome explanation involves the measuring of the contribution of each input feature in producing output of the distilled machine learning model 805. In various embodiments, the linear regression model can be expressed as a polynomial whose terms can be sorted by coefficient amplitude. With coefficient amplitude of polynomial terms of the linear regression model, the most discriminatory input features can be identified. For instance, the linear regression model can be represented by Equation 2, in which each term can be sorted by the absolute value of their coefficient aₙ. For example, if aⱼ is the largest coefficient out of all coefficients θ=a₁ . . . aₙ, then xᵢⱼ is the most important contributor to the output of the linear regression model A*.

A*_{θ}(xᵢ)=a₁xᵢ₁+a₂xᵢ₂+ . . . +aₙxᵢₙ Equation 2

Thus, with outcome explanation through listing and sorting contributions of input features within the distilled machine learning model 805, the most important elements of each input xᵢ may be identified, in various embodiments. Specifically, this represents which entries of the i-th column from the event tracing table of Table 2 are main contributors to the prediction output 706, i.e., the hardware events occurring at the i-th timestamp are considered in classifying malicious programs or normal programs. Thus, outcome explanation enables incorrect classifications to be handled by clearly pointing out the critical location (e.g., hardware event temporal dynamics at certain timestamps) that led to the misprediction.

In various embodiments, explainability is further provided by using Shapley analysis. Shapley values capture the marginal contribution of each player to the final result. Formally, as depicted in Equation 3, the marginal contribution of the i-th player in the game can be calculated by:

$${ϕ}_{i} = {\sum }_{S ⊆ \frac{N}{\{ i \}}} \frac{\vert S \vert ! ( M - \vert S \vert - 1 ) !}{M !} [ {f}_{x} ( S ⋃ \{ i \} ) - {f}_{x} ( S ) ] \qquad Equation 3$$

In Equation 3, the total number of players is |M|, S represents any subset of players that does not include the i-th player, and fₓ(·) represents the function to give the game result for the subset S. Intuitively, the values generated by Shapley analysis are a weighted average payoff gain that player i provides if added into every possible coalition without i.

To apply Shapley analysis in machine learning tasks, machine learning features can be assumed as the ‘players’ in a cooperative game. Shapley analysis is a local feature attribution technique that explains every prediction from the machine learning model as a summation of each individual feature contributions. For example, assuming the machine learning model 408 accepts three different features for Spectre & Meltdown detection, to compute the corresponding Shapley values, the analysis starts with a null model without any independent features. Next, the payoff gain is computed as each feature is added to the machine learning model in a sequence. Finally, an average is computed over all possible sequences. In this example, since there are three independent variables, 3! (i.e., six in total) sequences must be considered. The computation process for the Shapley value of the first feature is presented in Table 3.

TABLE 3

| Sequences | Marginal Contributions |
|---|---|
| 1, 2, 3 | [symbol] ({1}) − [symbol] (∅) |
| 1, 3, 2 | [symbol] ({1}) − [symbol] (∅) |
| 2, 1, 3 | [symbol] ({1, 2}) − [symbol] ({2}) |
| 2, 3, 1 | [symbol] ({1, 2, 3}) − [symbol] ({2, 3}) |
| 3, 1, 2 | [symbol] ({1, 3}) − [symbol] ({3}) |
| 3, 2, 1 | [symbol] ({1, 2, 3}) − [symbol] ({3, 2}) |

Here, [symbol] is the loss function. The loss function serves as the ‘score’ function to indicate how much payoff is currently accrued by applying existing features. For example, in the first row, the sequence is 1, 2, 3, meaning the first, second, and the third features are sequentially added into consideration for classification. Ø stands for the model without considering any features, which in the current example is a random guess classifier, and [symbol] (Ø) is the corresponding loss. Then, by adding the first feature into the scenario, {1} can be used to represent the dummy model that only uses this feature to perform prediction. The loss [symbol] ({1}) is then computed again. [symbol] ({1})− [symbol] (Ø) is the marginal contribution of the first feature for this specific sequence. The Shapley values for the first feature are obtained by computing the marginal contributions of all six sequences and taking the average. Similar computations happen for the other features. In this regard, the Shapley values are crucial indicators of the features' impact towards machine learning model decisions, and will be further explored below.

As previously described and illustrated in FIG. 4, the detection process 400 may include data augmentation and adversarial training 440. In various embodiments, data augmentation and adversarial training 440 involves synthesizing new evasive program samples (e.g., programs including unauthorized memory attack cyberattack code and having obfuscation) based at least in part on original malicious samples. The synthesized evasive program samples are intended to improve the machine learning model 408 to prevent incorrect predictions, as understood and explained in result interpretation 430. In various embodiments, multiple strategies of data augmentation can be employed in order to improve the machine learning model 408 including, but not limited to: (i) manual data augmentation, (ii) generative adversarial network (GAN) model-based data augmentation, (iii) diffusion model-based data augmentation, and (iv) ensemble boosting.

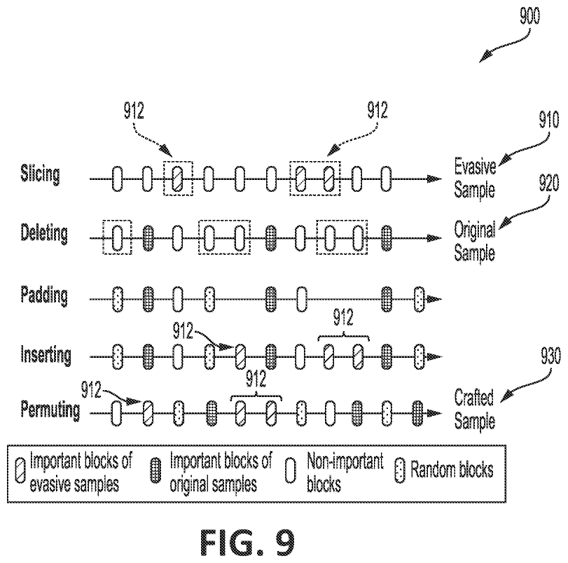

In various embodiments, a manual data augmentation process comprises five major steps: (i) slicing, (ii) deleting, (iii) padding, (iv) inserting, and (v) permuting. These five major steps are demonstrated in FIG. 9, which illustrates generation of an example synthesized evasive program sample. In various embodiments, data augmentation and adversarial training 440 comprises the manual data augmentation step of slicing or marking code or instruction portions corresponding to the most important timesteps from evasive program samples 910 that are incorrectly labelled by the classifier. As previously discussed, these most important timesteps are identified according to explainability provided by the distilled machine learning model 805. These code slices or instruction portions of evasive program samples 910 may be described as inducements 912. In various embodiments, a pool of inducements 912 is generated based at least in part on slicing a plurality of evasive program samples 910.

In various embodiments, data augmentation and adversarial training 440 comprises the manual data augmentation step of randomly deleting nonimportant and irrelevant portions of an original sample 920 to reduce the size of the original sample 920. An original sample 920 may be a sample already present in a plurality of program samples. In some example instances, an original sample 920 may have been previously generated according to the data augmentation process 900. The original sample 920 may be any of one of a normal process sample, a malicious process sample, or an evasive process sample, and the data augmentation process 900 may be performed for each of a plurality of program samples 920, effectively doubling the number of samples.

In various embodiments, the original sample 920 may then be padded with non-profitable code slices that are randomly generated and augmented. This padding is intended to mess-up and muddle overall statistics. Then, in various embodiments, bootstrapping techniques are applied to sample a pool of inducements 912 and to insert sampled inducements 912 into the original sample 920. Lastly, function blocks of the original sample 920 are permuted to form a synthesized evasive sample 930. Permutation causes the reordering of hardware events, making the fluctuation (e.g., time-based variations) of HPC values different from original samples.

This data augmentation process 900 is illustrated in FIG. 9, in which each row is a small example fragment of the full execution log of a program (e.g., a program sample), and each box represents one basic function block. As discussed, generation of the synthesized evasive sample 930 comprises (i) slicing important misleading activities from evasive attack codes that were previously mis-classified, (ii) deleting non-important blocks from an original program sample 920, (iii) padding the original program sample 920 with non-profitable blocks, (iv) inserting selected inducements into the original program sample 920, and (v) finally forming the synthesized evasive sample 930 from permutating basic function blocks of the original program sample 920. Using the synthesized evasive samples 930 and the augmented plurality of samples for training the machine learning model 408, the machine learning model 408 can be retrained or continuously trained. Algorithm 2 describes a process combining and integrating result interpretation 430 with data augmentation, thus forming adversarial training 440.

In various embodiments, a generative adversarial network (GAN) model-based data augmentation strategy can be employed in order to synthesize evasive samples. GAN model-based data augmentation consists of two neural network agents/models (called generator and discriminator) that compete with one another in a zero-sum game, where one agent's gain is another agent's loss. The generator is used to generate new plausible samples from the problem domain whereas the discriminator is used to classify the samples as real (from the domain) or fake (generated). The discriminator is then updated to get better at discriminating real and fake samples in subsequent iterations, and the generator is updated based on how well the generated samples fooled the discriminator. GAN model-based data augmentation aims at generating synthetic samples that possess a great level of similarity with real samples, which is achieved by improving both the generator and discriminator simultaneously. The discriminator is trained to distinguish between synthetic samples and real samples, which in turn encourages the generator to minimize this difference. Alternatively, the generator can also be trained to minimize the variance between synthetic samples and adversarial samples in feature space and, in doing so, the generator is expected to produce an augmented synthetic dataset whose elements are guaranteed to possess a certain level of characteristics associated with adversarial samples. This can help as a supplementary material to address the adversarial attack problem in machine learning.

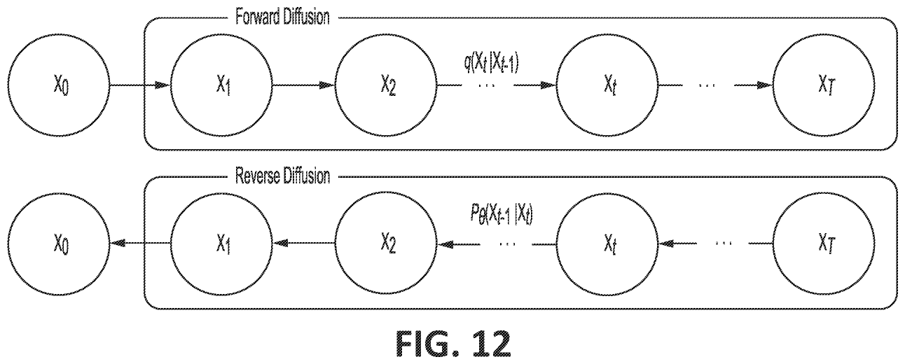

In various embodiments, a diffusion model-based data augmentation strategy can be employed to generate synthetic evasive samples. Diffusion model-based data augmentation explores the idea of reverse thinking. Fundamentally, diffusion models work by blurring training data through the successive addition of Gaussian noise, and then learning to recover the data by reversing the “noising” process. After training, the diffusion model can generate evasive samples by simply passing randomly sampled noise through the learned de-noising process. Formally, the goal of diffusion model is to determine a mapping from the original sample space to the latent space with a fixed Markov chain as shown in FIG. 12, where Xₜ represents the blurred data at step t. This chain gradually adds noise by applying a random posterior probability distribution q(Xₜ|Xₜ₋₁) to the data, and is asymptotically transformed to pure Gaussian noise. The goal of training is to learn the reverse process by traversing backwards along this chain and learn the reverse probability distribution p_{θ}(Xₜ₋₁|Xₜ) so as to recover the data samples.

As discussed above, ensemble boosting can be used to accelerate the training speed of the machine learning model 408. In various embodiments, a similar ensemble boosting strategy can be applied as a data augmentation strategy. This strategy effectively combines both GAN model-based data augmentation and diffusion model-based data augmentation strategies to provide better performance for data augmentation in terms of both data quality and time efficiency. In general, diffusion models provide better quality in terms of generality, but consume more computing resources. In this strategy, both the GAN and diffusion models are “ensembled” together to maximize performance. In this type of ensemble boosting framework, as illustrated in FIG. 11, multiple diverse models are created to craft synthetic evasive samples, and the ensemble boosting framework aggregates the overall outcomes as the final outputs, which can be further applied in the process of retraining the machine learning model 408, as shown in Algorithm 2.

This process is demonstrated in FIG. 8, and Algorithm 2 describes the entire data augmentation method along with result interpretation technique.

Algorithm 2: Training with Data Augmentation

| | Input : Original model (A), distill model (A*), |
|---|---|
| | sample pool P, number of iterations (k) |
| | Output: Optimized model, A′ |
| 1 | i = 1 |
| 2 | repeat |
| 3 | \| P′ = {x ϵ P\|A(x) ≠ lable(x)} |
| 4 | \| rank = sort(A*.coeff) |
| 5 | \| P_{adv} = craft(P′,rank) [symbol] craft adversarial |
| | \| samples |
| 6 | \| P = P ∪ P_{adv} |
| 7 | \| A = train(A, P) [symbol] retrain the model |
| 8 | \| A* = distill(A, P) |
| 9 | \| i++ |
| 10 | until i ≥ k; |
| 11 | Return A′ |

Generally then, a machine learning model 408 can be configured and optimized to detect programs 402 that include unauthorized memory access cyberattacks 404. In various embodiments, real-time detection using the machine learning model 408 may be reset after each run to ensure that measurements are independent across different runs (e.g., iterative evaluations of a program 402). In some example embodiments, this may include resetting HPC circuitry 325 and clearing or deleting values and data received from HPC circuitry 325. In various embodiments, each program 402 may be evaluated using the machine learning model 408 at a configured number of iterations to reduce the impact of nondeterminism. In one example embodiment, the configured number of iterations is 200.

Various embodiments of the present disclosure may utilize the detection process 400 in various forms for automated detection of unauthorized memory access cyberattacks. One example embodiment is a software-based implementation of the detection process 400, and such software-based implementation involves offline model training, online data collection, and real-time classification.

The machine learning model 408 can be trained offline in accordance with various embodiments of the present disclosure. Due to the structural design of the machine learning model 408, this framework can work with any deep learning library (e.g., TensorFlow, Pytorch, Sklearn) and is compatible with Central Processing Unit (CPU), Graphics Processing Units (GPU), as well as Google Transaction Processing Unit (TPU) based acceleration of the machine learning model 408.

In various embodiments, data collection can be implemented as a parallel thread. To achieve real-time data collection, the software-based implementation may require parallel execution of the “perf” tool or similar performance measurement commands at a configured sampling rate (e.g., 100 ms). The “perf” tool and/or similar commands provide details on hardware performance counter (HPC) events with accurate time frames. The selection of HPC events depends on the requirements and device characteristics. For example, the out-of-order memory lookup in Meltdown attacks generates significantly high number of page faults which can be used as an effective indicator. For Spectre attack, due to its abuse of branch prediction property, the total number of branch instructions and mispredictions are necessary to compute branch miss rate.

In various embodiments, these HPC event values are fed into the model to produce classification results. Once classified, there are two possible results: (i) benign: the current process is considered as benign execution and no further action needs to be taken, and (ii) malicious: a red flag is raised during program execution and automatic security actions may be performed, in various embodiments. For example, an interruption will happen to suspend the program and protect the memory to avoid further leakage. A scene clearing process follows this step to flush out remaining information in the cache and free the stack. Moreover, the malicious program will be marked with label and isolated in sandbox.

Another example embodiment is a hardware-based implementation of the detection process 400 which also covers offline model training, online data collection, and real-time classification. The trained model can be loaded to a Field Programmable Gate Array (FPGA) or memory. Similarly, the data collection and classification tasks can be implemented using FPGA or Application Specific Integrated Circuit (ASIC), and embedded into the target device. For example, an FPGA-based implementation can be integrated in a server or laptop that can perform the real-time data collection and cyberattack detection.

Yet another example embodiment is a hardware-software co-design that implements the detection process 400 using both hardware and software. For example, the data collection task can be performed in software, while the real-time classification can be performed in hardware using an ASIC or an FPGA.

### EXAMPLE STUDIES

The described example studies demonstrate the effectiveness of various embodiments described herein for detection of unauthorized memory access cyberattacks. The example studies described herein specifically describe detection of Spectre and Meltdown attacks. It will be understood that the example studies and various implementations (e.g., architectural implementations of a machine learning model) thereof are exemplary in nature and non-limiting.

The experimental evaluation is performed on a host machine with Intel i7 3.70 GHz CPU, 32 GB RAM and RTX 2080 256-bit GPU. Code was developed using Python for model training, with PyTorch as the machine learning library. To enable fair comparison with existing approaches, the experiments were deployed on the consistent benchmarks from SPEC integer benchmark. During program execution, performance counter values were extracted with “perf” tool at a sampling rate of 100 ms.

The machine learning model comprises a LSTM network and an MLP. The architecture of LSTM contains a one-hot encoding layer, a hidden layer with 32 nodes and a 50% dropout. The MLP is composed of 3 layers and 64 nodes. For input data, data samples consist of hardware performance counter values collected during the execution of both malicious (with implanted Spectre and/or Meltdown attacks) and benign programs. The initial pool of evasive attack samples were manually crafted by the following obfuscation techniques: 1) Strategy 1: Put attack into sleep between memory-flush. 2) Strategy 2: Insert redundant instructions for obfuscation.

The sampling happens at a rate of 100 ms. For each program, the collected traces are further formatted into event-tracing table as illustrated in Table 2. In terms of the size, the training data set comprises data collected from 200 runs of malicious programs, as well as 200 runs of benign programs. Average collected data size of each run is approximately 19.2 KB. Therefore, the total data size is 3840 (200*19.2) KB for each program. The system status was reset after each run to ensure that the measurements were independent across different runs.

Based on the above configuration, performance was compared in terms of detection accuracy and robustness between the following detection methods: (i) RDSM: State-of-the-art detection framework for both Spectre and Meltdown attacks; (ii) AT-RDSM: RDSM extended by training with adversarial samples to enable fair comparison; (iii) ODSA: State-of-the-art detection approach for Spectre attack using various implementations; and (iv) Proposed: detection technique using LSTM and explainable machine learning in accordance with various embodiments described herein (e.g., the machine learning model 408).

Table 4 compares the performance of the proposed approach in accordance with various embodiments of the present disclosure with the other aforementioned detection methods. Performance is compared with respect to detection rate (DR), false positive (FP) rate, and false negative (FN) rate.

TABLE 4

| | RDSM | | | AT-RDSM | | | ODSA-MLP | | | Proposed | | | |
|---|---|---|---|---|---|---|---|---|---|---|---|---|---|
| | DR | FP | FN | DR | FP | FN | DR | FP | FN | DR | FP | FN | improvement |
| Methods | (%) | (%) | (%) | (%) | (%) | (%) | (%) | (%) | (%) | (%) | (%) | (%) | over ODSA (%) |
| Spectre | 89.1 | 7.7 | 3.2 | 94.1 | 4.3 | 1.6 | 99.2 | 0.8 | 0.0 | 96.2 | 2.4 | 1.4 | −3.0 |
| Evasive-Spectre | 22.1 | 39.3 | 38.6 | 58.4 | 27.5 | 14.1 | 59.4 | 20.4 | 20.2 | 88.1 | 4.4 | 7.55 | 28.7 |
| Average | 55.6 | 23.5 | 20.9 | 72.6 | 15.9 | 7.9 | 79.3 | 10.6 | 10.1 | 94.4 | 2.3 | 3.3 | 18.9 |

ODSA (MLP) performed better compared to both RDSM and AT-RDSM. Although ODSA (MLP) provides outstanding detection performance for normal Spectre attacks, its performance drops to about 50% facing evasive attacks, which is comparable a random guess. In other words, ODSA is not suitable for deployment due to its lack of robustness against evasive Spectre attacks. The failure of ODSA in the presence of evasive attacks is likely due to the fact that the features extracted from evasive samples are almost identical with that from the benign programs. This is consistent with the feature analysis discussed in FIGS. 5A-B, when features are mingled in space, linear classifiers like LR, SVM or MLP are not expected to succeed. The machine learning model 408 significantly outperforms both RDSM and AT-RDSM for detecting Spectre attacks. While the performance of the detection process 400 in the example study (96.2% in Table 4) is comparable with ODSA (99.2% average in Table 4) for detecting Spectre attacks, the detection process 400 significantly outperforms (by 28.7%) ODSA in detecting evasive Spectre attacks.

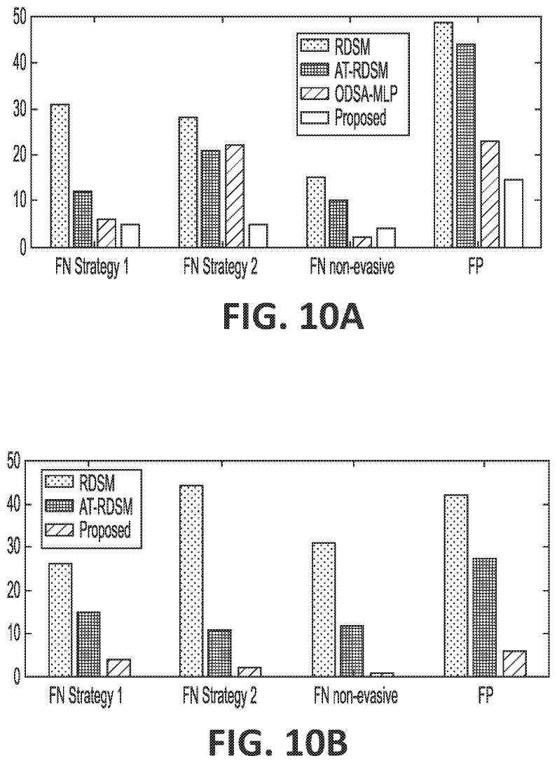

To demonstrate the effectiveness of the machine learning model 408, FIG. 10A plots the distribution of incorrect classification for four categories. The category on false positive (FP) represents the misclassified benign programs. The false negative (FN) category represents the attacks that bypassed detection, and this FN category is further divided into three subcategories: evasive attacks and two obfuscation strategies (aforementioned Strategy 1 and Strategy 2). As illustrated in FIG. 10A, ODSA is extremely sensitive to Strategy 2, where appending redundant instructions into the original program often misleads ODSA to make false negative predictions. This is expected from the mechanism of ODSA, where two hardware events (LLC miss rate, branch miss rate) are treated as the dominant measurement for classification. Therefore, Strategy 1 makes little contribution to the misclassification since randomly putting program into sleep will not affect the above events. However, the branch selection and cache references induced by redundant execution are detrimental to ODSA.

Table 5 compares performance of the machine learning model 408 with RDSM and AT-RDSM for detection of Meltdown attacks. ODSA did not report any results for Meltdown attacks.

TABLE 5

| | RDSM | | | AT-RDSM | | | Proposed | | | |
|---|---|---|---|---|---|---|---|---|---|---|
| | DR | FP | FN | DR | FP | FN | DR | FP | FN | improvement |
| Methods | (%) | (%) | (%) | (%) | (%) | (%) | (%) | (%) | (%) | over AT-RDSM (%) |
| Meltdown | 93.5 | 2.9 | 3.6 | 95.9 | 2.5 | 1.66 | 99.0 | 0 | 1.0 | 3.1 |
| Evasive-Meltdown | 19.2 | 25.6 | 55.2 | 55.6 | 22.8 | 21.6 | 94.5 | 2.3 | 3.2 | 38.9 |
| Average | 56.4 | 14.2 | 29.4 | 75.9 | 12.7 | 11.4 | 96.7 | 1.2 | 2.1 | 20.8 |

Since AT-RDSM outperforms RDSM in both categories, performance is compared with AT-RDSM in the last column. While AT-RDSM model provides 95.9% performance in detecting Meltdown attacks, its performance with evasive Meltdown drops to 55.6%, which is comparable to random guess. Such huge gap clearly indicates the instability of these methods with respect to obfuscation techniques. In contrast, the detection process 400 and the machine learning model 408 (e.g., “Proposed”) achieves more than 96% detection rate for non-evasive attacks. A high detection accuracy is maintained for evasive attacks. Most importantly, superior performance can be provided for detecting both evasive Spectre (88.1%) and evasive Meltdown (94.5%) attacks

Table 5 also reveals the weakness of previous works in terms of high false positive results. FIG. 10B shows the distribution of all misclassified inputs for four different categories. Clearly, RDSM is very vulnerable towards Strategy 2, since RDSM is based on the overall statistics from HPC circuitry 325. Inserting redundant instructions can hide the patterns of malicious behaviors such that a classifier cannot distinguish between malicious attacks and benign programs. While AT-RDSM improves the robustness against evasive attacks to some extent, it still has high false positive rate due to the lack of interpreting the reason for misclassification. Without the interpretation, the exact reason for wrong prediction is unclear and unknown, and adversarial samples are only blindly fed. This is expected to cause serious overfitting problems—some benign features in these samples are likely learned, inducing a high false positive rate.

Various embodiments provide improved performance for at least two major reasons. First, RNN handles time-sequential data so that it makes decisions utilizing potential information concealed in consecutive adjacent inputs, which provides more reliable classification results. Second, the critical difference between various embodiments described herein and AT-RDSM is that result interpretation 430 is performed before adversarial training 440, so that adversarial samples are carefully crafted. This “diagnose” before “prescribe” approach provides robustness to the machine learning model 408.

Additionally, various embodiments provide improved transparency and explainability for Spectre and Meltdown attack detection by utilizing Shapley analysis as detailed above. In machine learning, the task of classification commonly boils down to computing a separator and checking which side a sample falls on. Since Spectre attack detection is a binary classification problem, the task is further reduced to computing a threshold value and comparing the threshold with the model output.

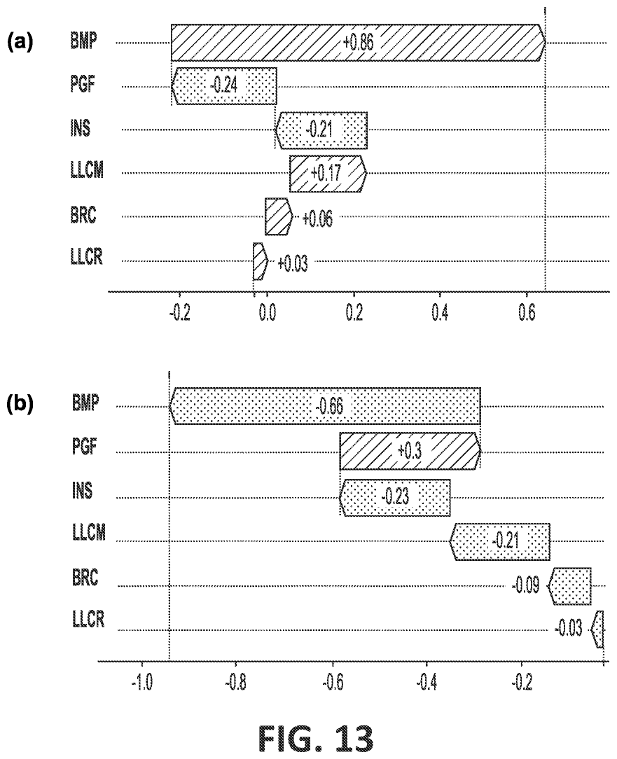

FIG. 13 shows two waterfall plots charting the Shapley values from a pair of samples analyzed by an exemplary machine learning model 408 of the present disclosure, specifically FIG. 13 depicts analysis of (a) a true positive sample and (b) a true negative sample. The waterfall plots clearly demonstrate the contribution of each feature and how they affect the classification decision of the machine learning model 408. The plus or minus sign illustrates whether the specific feature is supporting the sample to be positive (red bars), or whether the specific feature is supporting the sample to be negative (blue bars). The Shapley values along with each bar show the features' exact impact, and the summation of all Shapley values is compared with the threshold to give the final decision. As depicted in FIG. 13, branch mispredictions (BMP) and total page faults (PGF) are among the most important features. In the waterfall plot (a) of FIG. 13, the selected Spectre attack is an adversarial sample in which many redundant codes were inserted to induce extra page faults, and the PGF (total page faults) feature provides a negative contribution to the final decision. It will be appreciated that the waterfall plots clearly illustrate that various embodiments of machine learning model 408 are able to assign larger weights to the BMP feature such that the machine learning model 408 can still correctly predict the Spectre attack.

Table 6 compares the time efficiency for training and testing four different implementation methods including Random Forest (RF), Support vector machine (SVM), Recurrent Neural Network (RNN), and Ensemble Boosting. The first row lists the name of methods, while the next two rows provide the average training time and testing time respectively. The last column titled “Boosting” shows the time improvement provided by an exemplary machine learning model 408 compared to the other approaches machine learning approaches.

TABLE 6

| Implementations | RF | SVM | RNN | Boosting |
|---|---|---|---|---|
| Training | 5831 | 1130 | 7724 | 899 |
| Testing | 484 | 301 | 1562 | 287 |
| Total | 6315 | 1431 | 9286 | 1186 |

Clearly, the exemplary ensemble boosting framework achieves the best efficiency across both the training and testing benchmarks. The RNN-based model lags far behind the other approaches in time efficiency due to the utilization of a complex structure that requires tremendous debugging work and parameter tuning work. While the SVM provides better time efficiency than the RF- and RNN-based models, the exemplary ensemble boosting method is even faster. There are two major advantages of ensemble boosting over SVM. First, SVM dumps all data samples and collected features into a training phase, which incurs extra computation time for handling redundant features and duplicated samples, whereas the ensemble boosting framework performs partial sampling prior to training. Second, the ensemble boosting framework trains a sequence of lightweight models that requires much less time for processing and generates an aggregate prediction. The training time for each individual sub-model in the ensemble boosting framework is much shorter than that for all the other machine learning methods.

As discussed throughout the present disclosure, unauthorized memory access cyberattacks such as Spectre and Meltdown coupled with the cache-based side channel attacks arise as serious threats to modern computer systems and have dramatically changed perception of hardware security vulnerabilities. While existing defense mechanisms provide promising results, they have serious limitations, including significant performance penalty and hardware overhead. Some machine learning based solutions are also not effective in the face of evasive attacks with obfuscation or other deviation capabilities. In the present disclosure, such technical challenges are addressed by developing an explainable machine learning based detection framework. In various embodiments, a machine learning model 408 is able to make decisions utilizing hardware events generated from HPC circuitry 325. Moreover, the major contributors among all input features are identified in order to interpret the classification results, which is further utilized to defend against obfuscation techniques through adversarial training. Experimental results demonstrated that a machine learning model 408 in accordance with various embodiments provides comparable performance in detecting Spectre and Meltdown attacks, while achieving drastic improvement (28.7% for evasive Spectre and 38.9% for evasive Meltdown) in defending evasive attacks.

### CONCLUSION

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A method for detecting unauthorized memory access cyberattacks, the method comprising:
receiving, by a processor, hardware event data, wherein the hardware event data is collected from hardware performance counter (HPC) circuitry of a targeted device during execution of a program;
generating, by the processor, time-sequential hardware event data from the collected hardware event data, the time-sequential hardware event data describing changes in the hardware event data over a plurality of discrete timepoints; and
determining, by the processor, whether the program comprises an unauthorized memory access cyberattack based at least in part on providing the time-sequential hardware event data to a machine learning model configured to predict a presence of the unauthorized memory access cyberattack using the time-sequential hardware event data.

2. The method of claim 1, wherein the machine learning model comprises a long-short term memory (LSTM) mechanism configured to receive time-sequential hardware event data as input.

3. The method of claim 1, further comprising configuring the machine learning model to predict the presence of the unauthorized memory access cyberattack, wherein configuring the machine learning model comprises:
training the machine learning model with a plurality of program samples each labelled to indicate whether a program sample includes an unauthorized memory access cyberattack;
generating a distilled machine learning model configured to generate similar outputs to the machine learning model;
identifying one or more significant timepoints spanned by the time-sequential hardware event data using the distilled machine learning model;
generating a plurality of synthesized program samples using the one or more significant timepoints; and
re-training the machine learning model using the plurality of program samples and the plurality of synthesized program samples.

4. The method of claim 3, wherein generating the plurality of synthesized program samples further comprises:
executing one or more data augmentation operations in a machine learning model ensemble boosting framework, wherein the one or more data augmentation operations comprise manual data augmentation operations, generative adversarial network (GAN) model-based data augmentation operations, and diffusion model-based data augmentation operations.

5. The method of claim 4, wherein the manual data augmentation operations comprise:
slicing portions of one or more program samples each labelled to indicate presence of an unauthorized memory access cyberattack and each mis-classified by the machine learning model;
inserting the sliced portions within an original program sample of the plurality of program samples; and
generating a synthesized program sample based at least in part on permutating function blocks of the original program sample.

6. The method of claim 3, wherein the machine learning model is trained and re-trained using stochastic gradient descent and cross-entropy loss.

7. The method of claim 3, wherein re-training the machine learning model further comprises employing a machine learning model ensemble boosting framework, wherein the machine learning model ensemble boosting framework comprises previous iterations of the machine learning model.

8. The method of claim 3, wherein the distilled machine learning model is a linear regression model comprising a plurality of polynomial terms, the plurality of polynomial terms being used to identify the one or more significant timepoints.

9. The method of claim 1, wherein the collected hardware event data includes (i) branch mis-prediction rate, (ii) a number of low-level cache references, and (iii) a number of low-level cache misses.

10. A computer program product for detecting unauthorized memory access cyberattacks, the computer program product comprising at least one non-transitory computer-readable storage medium having computer-executable program code instructions stored therein, the computer-executable program code instructions comprising program code instructions to:
receive hardware event data, wherein the hardware event data is collected from hardware performance counter (HPC) circuitry of a targeted device during execution of a program;
generate time-sequential hardware event data from the collected hardware event data, the time-sequential hardware event data describing changes in the hardware event data over a plurality of discrete timepoints; and
determine whether the program comprises an unauthorized memory access cyberattack based at least in part on providing the time-sequential hardware event data to a machine learning model configured to predict a presence of the unauthorized memory access cyberattack using the time-sequential hardware event data.

11. The computer program product of claim 10, wherein the machine learning model comprises a long-short term memory (LSTM) mechanism configured to receive time-sequential hardware event data as input.

12. The computer program product of claim 10, further comprising program code instructions to configure the machine learning model to predict the presence of the unauthorized memory access cyberattack, wherein the computer program code instructions to configure the machine learning model further comprise instructions to:
train the machine learning model with a plurality of program samples each labelled to indicate whether a program sample includes an unauthorized memory access cyberattack;
generate a distilled machine learning model configured to generate similar outputs to the machine learning model;
identify one or more significant timepoints spanned by the time-sequential hardware event data using the distilled machine learning model;
generate a plurality of synthesized program samples using the one or more significant timepoints; and
re-train the machine learning model using the plurality of program samples and the plurality of synthesized program samples.

13. The computer program product of claim 12, wherein the computer program code instructions to generate the plurality of synthesized program samples further comprise instructions to:
execute one or more data augmentation operations in a machine learning model ensemble boosting framework, wherein the one or more data augmentation operations comprise manual data augmentation operations, generative adversarial network (GAN) model-based data augmentation operations, and diffusion model-based data augmentation operations.

14. The computer program product of claim 13, wherein the manual data augmentation operations comprise computer program code instructions to:
slice portions of one or more program samples each labelled to indicate presence of an unauthorized memory access cyberattack and each mis-classified by the machine learning model;
insert the sliced portions within an original program sample of the plurality of program samples; and
generate a synthesized program sample based at least in part on permutating function blocks of the original program sample.

15. The computer program product of claim 12, wherein the machine learning model is trained and re-trained using stochastic gradient descent and cross-entropy loss.

16. The computer program product of claim 12, wherein the computer program code instructions to re-train the machine learning model further comprise instructions to employ a machine learning model ensemble boosting framework, wherein the machine learning model ensemble boosting framework comprises previous iterations of the machine learning model.

17. The computer program product of claim 12, wherein the distilled machine learning model is a linear regression model comprising a plurality of polynomial terms, the plurality of polynomial terms being used to identify the one or more significant timepoints.

18. The computer program product of claim 10, wherein the collected hardware event data includes (i) branch mis-prediction rate, (ii) a number of low-level cache references, and (iii) a number of low-level cache misses.

19. A system for detecting unauthorized memory access cyberattacks, the system comprising one or more computers and one or more storage devices storing instructions that are operable, when executed by the one or more computers, to cause the one or more computers to:
receive hardware event data, wherein the hardware event data is collected from hardware performance counter (HPC) circuitry of a targeted device during execution of a program;
collect hardware event data from hardware performance counter (HPC) circuitry of a targeted device during execution of a program;
generate time-sequential hardware event data from the collected hardware event data, the time-sequential hardware event data describing changes in the hardware event data over a plurality of discrete timepoints; and
determine, by the processor, whether the program comprises an unauthorized memory access cyberattack based at least in part on providing the time-sequential hardware event data to a machine learning model configured to predict a presence of the unauthorized memory access cyberattack using the time-sequential hardware event data.

20. The system of claim 19, wherein the machine learning model comprises a long-short term memory (LSTM) mechanism configured to receive time-sequential hardware event data as input.

21. The system of claim 19, further comprising instructions to configure the machine learning model to predict the presence of the unauthorized memory access cyberattack, wherein the instructions to configure the machine learning model further cause the one or more computers to:
train the machine learning model with a plurality of program samples each labelled to indicate whether a program sample includes an unauthorized memory access cyberattack;
generate a distilled machine learning model configured to generate similar outputs to the machine learning model;
identify one or more significant timepoints spanned by the time-sequential hardware event data using the distilled machine learning model;
generate a plurality of synthesized program samples using the one or more significant timepoints; and
re-train the machine learning model using the plurality of program samples and the plurality of synthesized program samples.

22. The system of claim 21, wherein the instructions to generate the plurality of synthesized program samples further cause the one or more computers to:
execute one or more data augmentation operations in a machine learning model ensemble boosting framework, wherein the one or more data augmentation operations comprise manual data augmentation operations, generative adversarial network (GAN) model-based data augmentation operations, and diffusion model-based data augmentation operations.

23. The system of claim 22, wherein the manual data augmentation operations comprise instructions to:
slice portions of one or more program samples each labelled to indicate presence of an unauthorized memory access cyberattack and each mis-classified by the machine learning model;
insert the sliced portions within an original program sample of the plurality of program samples; and
generate a synthesized program sample based at least in part on permutating function blocks of the original program sample.

24. The system of claim 21, wherein the machine learning model is trained and re-trained using stochastic gradient descent and cross-entropy loss.

25. The system of claim 21, wherein the instructions to re-train the machine learning model further comprise instructions that cause the one or more computers to:
employ a machine learning model ensemble boosting framework, wherein the machine learning model ensemble boosting framework comprises previous iterations of the machine learning model.

26. The system of claim 21, wherein the distilled machine learning model is a linear regression model comprising a plurality of polynomial terms, the plurality of polynomial terms being used to identify the one or more significant timepoints.

27. The system of claim 19, wherein the collected hardware event data includes (i) branch mis-prediction rate, (ii) a number of low-level cache references, and (iii) a number of low-level cache misses.
